(19) United States
(12) Patent Application Publication
(10) Pub. No.: US 2017/0148277 A1
(43) Pub. Date: May 25, 2017

(54) GAMES, GAMING DEVICES AND GAME SYSTEMS HAVING A GAME INDICIA GRAB FEATURE

(71) Applicant: Blastworks, Inc., Seattle, WA (US)

(72) Inventor: Craig Falciglia, Waldwick, NJ (US)

(21) Appl. No.: 15/355,263

(22) Filed: Nov. 18, 2016

Related U.S. Application Data
(60) Provisional application No. 62/257,807, filed on Nov. 20, 2015.

(51) Int. Cl. G07F 17/32

(52) U.S. Cl. CPC G07F 17/3293; G07F 17/3211; G07F 17/3227

(57) ABSTRACT

In a game, game players attempt to collect winning combinations of game indicia. Called game indicia are displayed to the players. Only the first player to select or grab a called game indicium collects the game indicium, while the other unsuccessful players do not collect the indicium. The outcome of the game is determined by comparing the sets of game indicia collected by each player to one or more pay tables or to the sets of other players. In one embodiment, players attempt to grab playing cards to form five card poker hands.

### RELATED APPLICATION DATA

The present invention claims priority to, and incorporates herein in its entirety by reference, U.S. Provisional Application Ser. No. 62/257,807, filed Nov. 20, 2015.

### FIELD OF THE INVENTION

The present invention relates to methods of presenting and playing games and gaming machines configured to present games.

### BACKGROUND OF THE INVENTION

Game developers continue to seek to develop games which are new and exciting to play. In the wagering game space, casino game manufacturers have adapted traditional card games to electronic gaming machines, such as in the form of video poker games and the like. Traditional spinning reel slot machines have been adapted to video form. These games may further include various bonus events or secondary features.

One aspect of traditional slot and video wagering games presented by gaming machines is that they are generally for play by a single player. Thus, the game play is a generally solitary event. While some tournament style games have been developed, they still often lack player interaction.

Accordingly, the invention herein has been developed to address these and other issues.

### SUMMARY OF THE INVENTION

Embodiments of the invention comprise methods of playing and/or presenting games, gaming machines or devices, and gaming systems. One embodiment of the invention comprises a game having game indicia selection or grab feature.

In one embodiment of a game method, a game is presented to one or more players. Each player may participate in the game via a gaming machine, at a gaming table or the like.

The game proceeds with one or more rounds or turns. In each turn, a game indicium is selected or called and is displayed to the players. The players may attempt to select or grab the called game indicium. In one embodiment, the first player (and only the first player) to select or grab the called game indicium is provided the opportunity to play the called game indicium (whereas the remaining players may not play the called game indicium). In one embodiment, when the called game indicium is displayed, each player may provide input in an attempt to select or grab the called game indicium, such as input to a “grab” button.

In one embodiment, an object of the game is for each player to collect a set of game indicia, wherein the outcome of the game is determined relative to that collected set of game indicia. In one embodiment, the game outcome may be determined by comparing the set of game indicia collected by the player to a pay table or to the set of game indicia collected by other players.

In one embodiment, a player may be required to place an entry fee or place a wager in order to participate in the game. In a wagering game configuration, winnings may be paid to the winning player(s).

One embodiment of a game of the invention is a card game in which players collect five playing cards to form a best five card poker hand. The players vie for displayed playing cards, attempting to only grab cards which benefit their hand, while attempting to grab those cards quickly enough to win the cards.

In one embodiment, the game may be presented via a gaming system which includes at least one game server which communicates with gaming machines which are played by the players. Such gaming machines might comprise casino style gaming machines, computing devices or the like, such as in casino or Internet environments. In other embodiments, the game may be presented at a game table.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine in accordance with one embodiment of the invention;

FIG. 2 illustrates other embodiments of gaming machines in accordance with the invention relative to an embodiment of a gaming system of the invention; and

FIG. 3 is a flow diagram of an embodiment of a method of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games, and gaming machines and systems configured to present games. In one embodiment, the methods of game play and presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

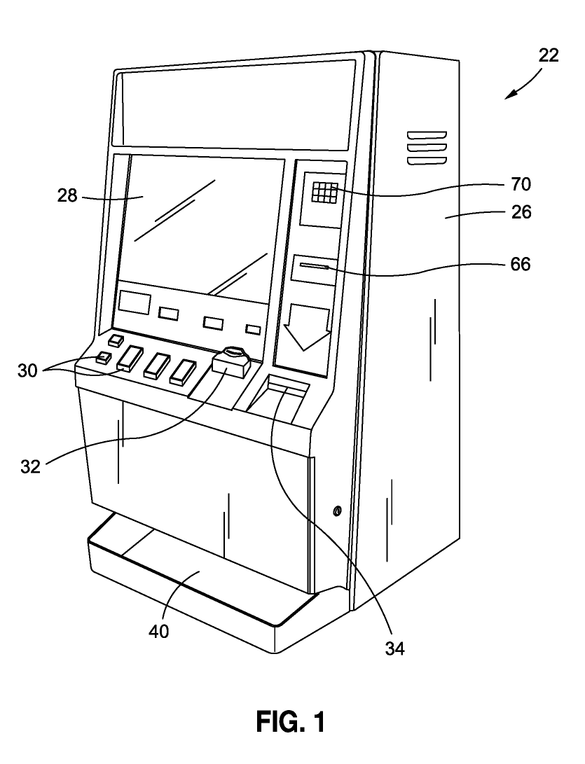

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be “grabbed,” to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising displayed cards, as detailed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 22 may also include one or more random number generators for generating random numbers (such as implemented by a random number generator software module stored in the memory and executable by the processor or controller), such as for use in selecting cards and for presenting the game in a random fashion (e.g. whereby the game is presented in a manner in which the player cannot control the outcome) or, as disclosed below, in a pseudo-random fashion (e.g. such as where the game includes a skill component which can affect the outcome of the game).

Preferably, the controller is configured to execute machine readable code or instructions (e.g. software) which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. As indicated above, the machine readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

The gaming machine 22 may, as noted above, be part of a system which includes other devices. For example, the gaming machine 22 may communicate with one or more casino systems, such as a player tracking server or system, an accounting system or server, a ticketing system, a bonusing system, a tournament system, other gaming machines, and external devices.

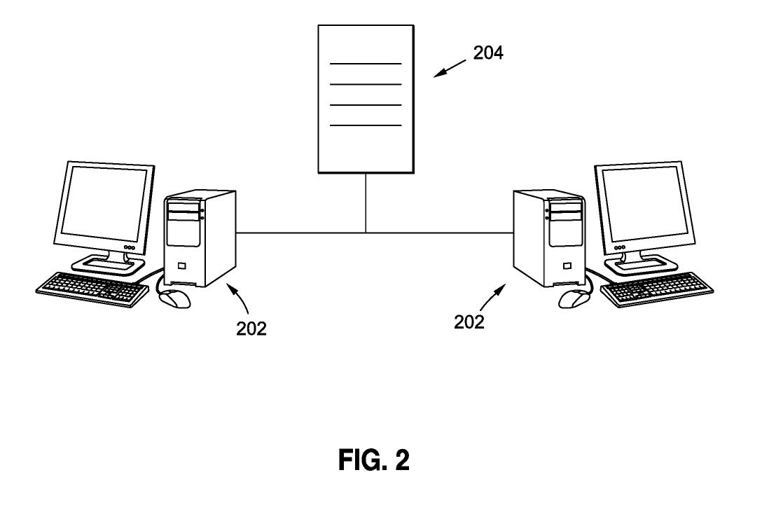

For example, as illustrated in FIG. 2, in one embodiment, a player might utilize such a gaming machine 202 to connect or log into a game server 204. The game server 204 (such as a controller thereof) may cause game information to be delivered to the player's gaming machine/computer 202 via a communication link and then be displayed on a display of the player's gaming machine/computer 202. The communication link might comprise or include the Internet, a casino network such as a wired or wireless LAN, or combinations of public and/or private networks including wired and/or wireless links.

Similarly, a casino-style gaming machine 22 such as that described above might connect to a game server or controller and obtain game information from the server and/or exchange information with the game server, such as in a “server-based” gaming system.

The game server or controller may comprise more than one device. For example, in a server-based environment, a controller at a server may generate game information and transmit that information to a local controller at a gaming machine. The local controller at the gaming machine may then cause game information to be displayed on one or more associated displays.

In a server-based configuration, two or more gaming machines may be connected to the game server, such as illustrated in FIG. 2. For example, in an Internet based configuration, two or more players might connect to a game server via their gaming machines/computers. In a casino environment, two or more gaming machines might similarly be linked to a casino game server. In other embodiments, it is possible for two or more players to play a single gaming machine or device. For example, a single gaming machine might include multiple player stations or displays or be configured to simultaneously display game information for multiple players.

In one embodiment, one or more players of the game might be implemented as or comprise automated players or “Bots”. Such a Bot might be implemented via a gaming machine or a game server. For example, a live player of a gaming machine might play against a Bot which is implemented by the gaming machine, a game server or another gaming machine.

It is also possible for games of the invention to be played or present at one or more game tables or the like. For example, such a table might comprise a casino-style gaming table having a top or playing surface. That surface may define various areas or information, such as by printing or topographical features formed in or on the table. Such areas might comprise, for example, wagering areas in which monies or chips might be placed, game indicia areas, etc. The table might define one or more player positions and, in one embodiment, a dealer or house position. Further, the game might be presented or played using physical game indicia or game pieces bearing game indicia, such as physical playing cards or the like.

One embodiment of a method of playing and presenting a game in accordance with an embodiment of the invention will now be described

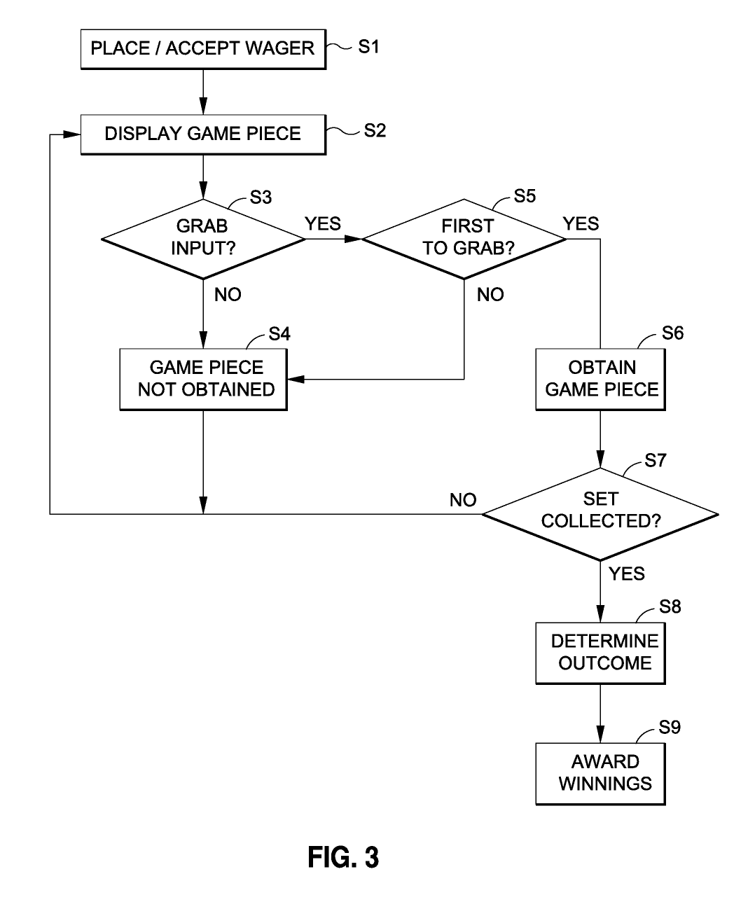

In one embodiment a player enters the game. In one embodiment, such could comprise simply providing a “play game” input. In other embodiments, a player may only be permitted to play the game upon payment, such by placing an entry fee or a wager, such as in step S1 as illustrated in FIG. 3. As indicated above, such may comprise a player providing a number of credits at a gaming machine, using a credit card or other financial account or the like to provide monetary value funds or other credits or the like. In other embodiments, the entry fee or wager might comprise points or other elements.

In some embodiments, the size of the entry fee or wager might affect certain features of the game, such as the type and/or size of prizes or winnings which might be awarded for winning outcomes.

In one embodiment, the object of the game is for a player to collect game indicia, such as to form a set of game indicia which comprises a winning set of indicia, such as defined by a pay table or as compared to the indicium of one or more other players. In one embodiment, for example, each player collects five indicia to form a five card poker hand.

In one embodiment, the game may be played between at least one live player and a Bot or AI player. In other embodiments, the game may only be played between two or more players. In such an embodiment, the game will not proceed until at least two live players are detected (such as when two live players have placed wagers).

The game is preferably presented in one or more rounds to turns. In each round, one or more game indicia are displayed or “called”, as in step S2. The game indicia may be, for example, randomly selected from a set of game indicia. For example, relative to a card game, individual playing cards may be selected from one or more decks of cards (such as from one or more standard decks of 52 cards comprising the cards 2, 3, 4, 5, 6, 7, 8, 9, 10, Jack, Queen, King and Ace, in the four suits hearts, diamonds, clubs and spades; or other decks, such as including Jokers, wildcards or the like).

Preferably, the called game indicia or game piece is displayed to each player (such as by displaying a graphical representation of the game indicia or game piece or even a photograph or video of an actual physical game piece, or by holding up the game piece for viewing). For example, in a server-based game environment, the game server may randomly select a playing card and send information to each gaming machine regarding that card so as to cause each gaming machine to display an image of the playing card. In a game table environment, a physical playing card might be selected from a deck or shoe or cards and be placed in an area of the table. Of course, game indicia might be displayed in other manners, such as at large common displays near gaming machines or a gaming table, or in other manners.

In one embodiment, when a game indicium is displayed, a player may select or grab the indicium, as in step S3. In an electronic game environment, for example, the player might touch a touch screen associated with a video display in the area where the indicium is displayed, press a button (such as “Grab” button), or provide other required input to their gaming machine. In a table environment, such might comprise a player reaching out and physically grabbing the playing card, such as with their hand. In a server-based system, the server may receive input from the gaming machines and determine which player “grabbed” the indicium first (for example, when a player presses the “grab” button, the gaming machine may send a signal to the game server and the game server may then evaluate which “grab” input was first, either with reference to the order in which the signals were received at the server, time stamps associated with the inputs at the gaming machines or the like).

In one embodiment, if the player did not grab the indicium (either electively or because they were, for example, not the first player to grab it), then the player may be required to wait for the next indicium to be selected and displayed in another round of play, as in steps S4 and S5. In one embodiment, for example, none of the players might grab or select the indicium. In such event, a new game indicium may be selected and displayed (for example, if no player grabs or selects a displayed indicium within x seconds of it being displayed, it may be removed and a new game indicium may be selected and displayed to the players).

In this configuration, only certain players, and not all players, are allowed to obtain or use a selected or displayed game indicium. In one embodiment, after a game indicium or game piece is displayed, only the first player among the two or more players who provides a designated input (such as a “grab” input), obtains and can use or play the game indicium or game piece. The remaining players are not allowed to obtain or play the game piece. Thus, as one example, the game piece comprising the A♡ might be displayed. Player A and Player B might both hit a “grab” button at their gaming machine. However, it may be determined that Player B hit their button first. As a result, Player B captures the A♡ for use in the game, while Player A does not.

It will be appreciated that in one embodiment of the game, only a single player might be permitted to select or grab a displayed game indicium to the exclusion of other players. However, in other embodiments, more than one player, but preferably not all players, may grab or select a displayed game indicium. For example, in a game where there are 100 players, the first 2, 5 or even 10 out of the 100 players to select or grab the indicium might be permitted to play the indicium.

If the player did successfully grab the indicium, then the game indicium may be added to the player's set of indicia, as in step S6, so long as the player's set of indicia is not already full. In one embodiment, once a player has selected or grabbed a sufficient number of game indicia to complete their set of indicia, they may be prevented from grabbing or selecting further indicia. For example, the player's gaming machine may be locked or frozen (such as via a signal from the game server) in a manner which at least prevents the player from attempting to grab a called game indicium. For example, during that time a player's “grab” button may be inactivated. In other embodiments, the player might be permitted to attempt to grab or select a called indicium, but the gaming machine, game sever, a dealer or the like may simply ignore any input by the player during a lost turn or round. In yet another embodiment, a player might still be permitted to grab indicia, such as to try and replace existing grabbed indicia with better indicia. For example, a player who has the cards A, A, 4, 6, 8 might successfully grab another A and might provide input for it to replace the 4, thereby resulting in the hand A, A, A, 6, 8.

In one embodiment, a number of game turns are performed until each player has collected a certain number of game indicia, such as by completing or filling their set of game indicia, as in step S7. For example, where the goal of the game is for each player to form a five card poker hand, the game turns end after each player has successfully grabbed five cards. In other embodiments, the game turns might end after a certain number of game indicia is displayed, regardless of whether the players have completed their sets of game indicia.

In one embodiment, game indicia positions might be displayed to each player. For example, five positions might be displayed on a game table or on a display of a gaming machine to the player. Each time a player grabs a game indicium, the game indicium may be associated with one of those positions, thus aiding the player in tracking their filling of the positions. For example, relative to a card version of the game, the Ten of Hearts might be displayed, such as in a common area of a game table or on a display. A player might successfully grab that card. The Ten of Hearts might be moved to an empty game indicium position corresponding to that player at a game table or on the display of the gaming machine. It is noted that game indicia collected by other players may or may not be displayed to each other player. For example, a player may not be able to see the game indicia collected by other players, thus forcing the player to play “in the blind” as to what value hand they likely need to form in order to beat another player.

In one embodiment, only a certain number of game indicia may be selected or called. As one example, two players might play a poker game according to the invention. In one embodiment, playing cards might be selected from a deck until both players have formed their five card hand, regardless of how many cards must be selected and displayed until the players' hands are formed. For example, a number of game cards might be selected and displayed but not be grabbed by either player (while each player waits for a better card to be displayed). However, in another embodiment, only a certain number of game indicia may be selected and displayed. This might require a player to grab a game indicium, even if it is not the most desirable, to ensure that they collect a sufficient number of game indicia to complete their set. For example, relative to the two player example described above, in another configuration a maximum of fifteen playing cards might be selected and displayed. This requires each player to make decisions about which cards to select or pass upon, while taking care that they can collect five cards before all fifteen cards are displayed.

In one variation, a set of game indicia may be selected and then displayed one at a time. If no player initially selects or grabs an indicium, then it may be redisplayed later. For example, relative to a two player poker game, ten playing cards might be selected for display. If one of those cards is not initially selected by either player, then it is redisplayed at a later time, whereby a player may end up being required to select or grab one of the cards at the end in order to complete their hand.

In one embodiment, a player might be permitted to grab and discard or waste a called game indicium, such as to prevent that game indicium from being obtained by another player. In one embodiment, the number of times that a player might waste a game indicium (such as a card) might be limited, such as to one or two times per game, such as to prevent a player from abusing the feature or completely blocking other players. In one embodiment, when a player grabs and wastes a game indicium (such as a card), the game indicium goes into a waste or discard pile and can no longer be used in the game. If this option is provided, once a player grabs a game indicium, the options “play” or “waste” might appear, forcing the player to make an election.

In one embodiment, the one or more players collect N game indicia. In such a configuration, a number of game indicia equal to or greater than N times the number of players may be selected or displayed. For example, if two players are each required to collect five game indicia (N=5), then at least 10 game indicia may be selected and called (N*2 players), whereby each player has an opportunity to collect the required number of game indicia.

In one embodiment, it is also possible for players to start with one or more cards or game indicia and then attempt to “fill” or complete a hand using grabbed indicia. For example, each player might be pre-dealt 3 cards for use in forming a 5 card poker hand. Additional cards might then be displayed which can be selected or grabbed as indicated above, for completing the hand.

In another embodiment, the cards which a player grabs or selects might be used in conjunction with one or more community cards. For example, 2 or 3 community cards might be dealt. Each player might then attempt to select or grab and additional 5 cards and then use those cards with the community cards to form a best 5 card hand.

The outcome of the game may be determined in various manners, as in step S8. For example, one or more predetermined game outcomes may be designated as winning outcomes. For example, a pay table of winning losing outcomes may be defined (which winning outcomes preferably comprise a sub-set of all possible outcomes, where the outcomes which are not winning are losing). In another embodiment, players might play against one another, such as where rankings of indicia or groups of indicia are defined and the player(s) with the highest ranking are declared the winner(s). The criteria for winning outcomes might depend upon the game. For example, the game could be played as a poker-style game where the player attempts to form the highest ranking poker hand. In other games, the player might attempt to form certain designated combinations of cards (such as just Flushes, just Straights or the like), or might try and form two or more hands. Of course, other criteria might be utilized relative to other game pieces, such as where the game indicia or game pieces comprise dice or the like.

It is also possible for players to play against a dealer. For example, a 5 card poker hand may be dealt to a dealer. Each player may attempt to form a 5 card hand by selecting or grabbing indicia. The outcome of the game may then be determined by comparing each player's hand to the dealer's hand, wherein the player wins if their hand outranks the dealer's hand (but loses if it does not).

Winnings may be awarded to the one or more winning players, as in step S9. Awards for winning outcomes of the game may be defined by a pay table, such as dependent upon the size of the player's wager, or might comprise a pot or jackpot, fixed award, non-monetary prizes or the like. When the game is presented via an electronic gaming machine or a gaming system, the pay table may be stored in a memory or data storage device of the gaming machine or a server of the gaming system. In a table environment, winnings might be paid in the form of chips or the like.

When the game is presented via a gaming machine, such as by the system illustrated in FIG. 2, steps of the invention may be performed by the gaming machine and/or server. For example, the game server may be configured to randomly generate game indicia, determine game outcomes and the like, etc. In such a configuration, steps of the game might be implemented via machine readable code which is stored at a memory of the game server and executed by the controller of the game server. The game might be presented via a browser or other application running on the player's gaming machine which communicates with the game server.

The invention has a number of exciting features. One aspect of the invention is a game where players of the game vie for selected or called game indicia. In one embodiment of the invention, only the first player (or a sub-set of the players) to select or grab the game indicium can play or use that indicium—and the remaining players are not permitted to use that indicium. In one embodiment, this introduces an exciting skill feature into the game, which skill feature impacts the outcome of the game. The feature generates excitement because it pits players against one another during the game and puts pressure on the players to quickly view and select indicia as they are displayed. In addition, the pace of the game is heightened because players will naturally want to select displayed indicia as fast as possible so as to not get beat out by other players. This causes the game to be fast paced.

It will be appreciated that features of the invention may be applied to different types of games. For example, the game could comprise a five card poker game. The game could comprise a seven card poker game where each player grabs or selects seven cards and forms the best five card hand from those cards. The game could be a Pai Gow, baccarat, blackjack or other game.

In one embodiment, players might attempt to form poker hands. In other embodiments, however, players might attempt to collect certain sets of game indicia, such as particular combinations of cards. In one embodiment, for example, the game indicia might comprise cards bearing images associated with each of the four seasons. The player who collects the most cards associated with the same season might be declared to be the winner.

In one embodiment, the game could be implemented as a tournament type game where the top players of each game (such as by score, rank or the like) advance to the next game, with the goal to be the last player.

In one embodiment of the game, more than one game indicium might be called or displayed during each game round. For example, two or more playing cards might be selected and displayed at the same time, forcing the players to evaluate the group of cards and hopefully select the most valuable one or more cards from the displayed cards. For example, five playing cards might be displayed. In one embodiment, players would attempt to grab one or more cards before the other players (thus, some players might successfully grab one or more cards while other players might be unsuccessful in grabbing any cards; in some embodiments a player might be limited to grabbing a single card from the multiple displayed cards, thus forcing the player to try and quickly pick the best card) In another variation, the “grab” feature might be intermixed with the call of game indicia which all players may play. For example, in one embodiment of a game certain game indicia may be called which all players may play. At certain times, a called game indicia may be displayed with a “GRAB” identifier, meaning that only the first player to grab that called indicia may attempt to play that game indicium.

In one embodiment, once a called indicium is grabbed and played by a player (or wasted/discarded, if that option exists), then that called indicium does not appear again in the game. For example, once a particular playing card has been played or discarded, another instance of that playing card will not appear during the game (such as to be consistent with the play of card games using a single deck of cards). In other embodiments, it is possible for a game indicium to be called more than once. For example, game variations might permit a game indicium to be called more than once, such as to permit different players to obtain the game indicium at different time (e.g. a first player might grab the game indicium first and block other players from getting it initially, but so long as the game has not ended, a second player might grab that same indicium when it is called later).

Likewise, more than one player, but not all players, might be permitted to grab or select a displayed game indicium. For example, in a game of ten players, the first two players might be permitted to grab a displayed indicium.

The game may be presented or played by just a single game player, such as against a pay table. In a preferred embodiment, however, the game is played as a multi-player game. In that configuration, the game may not start until a sufficient number of players have entered the game.

It will be understood that the above described arrangements of apparatus and the method there from are merely illustrative of applications of the principles of this invention and many other embodiments and modifications may be made without departing from the spirit and scope of the invention as defined in the claims.

1.-3. (canceled)

4. A method of presenting a game played by two or more players via a gaming system comprising at least one game server, a first gaming machine and at least one second gaming machine, said first and second gaming machines each having a wager accepting device configured to accept an item associated with a monetary value, thereby creating a credit balance, and at least one display device, comprising the steps of:
receiving a wager from a player of said first gaming machine and reducing said credit balance associated with said first gaming machine;
receiving a wager from a player of said second gaming machine and reducing said credit balance associated with said second gaming machine;
implementing a plurality of game turns comprising:
selecting, at said at least one game server, at least one called game indicia from a set of game indicia and causing said at least one called game indicia to be displayed at said at least one display device of said first gaming machine and said at least one display device of said second gaming machine;
determining, at said at least one game server, a first player of said two or more players to select said at least one called game indicia; and
permitting said first player to select said at least one called game indicia to collect said called game indicia while preventing each remaining player of said two or more players from collecting said called game indicia;
and, at the end of said plurality of game turns:
evaluating an outcome of said game with reference to the game indicia collected by each player; and
providing a credit balance increasing award when at least one winning game outcome is obtained.

5. The method in accordance with claim 4 wherein each player is required to collect a set of N game indicia and said plurality of game turns comprises at least N*2.

6. The method in accordance with claim 4 wherein said set of game indicia comprises one or more decks of playing cards.

7. The method in accordance with claim 4 wherein said called game indicia comprises a playing card.

8. The method in accordance with claim 4 wherein said step of collecting comprises associating said called game indicia with a hand of said first player to select said called game indicia.

9. The method in accordance with claim 4 wherein said step of evaluating comprises evaluating said game indicia collected by each player for a highest poker hand ranking.

10. The method in accordance with claim 4 further comprising allowing said first player to select said called game indicia to replace another game indicia associated with a hand of said first player with said called game indicia.

11. The method in accordance with claim 4 further comprising allowing said first player to select said called game indicia to discard said collected called game indicia.

12. The method in accordance with claim 4 wherein said first player to select said called gaming indicia comprises a first player of said two or more players to provide a designated input to their associated gaming machine.

13. A gaming system comprising:
at least one game server comprising a memory device, a processor, at least one communication interface which permits said game server to transmit information to a first gaming machine and a second gaming machine and to receive information from said first and second gaming machines, said first and second gaming machines each having a wager accepting device configured to accept an item associated with a monetary value, thereby creating a credit balance, and at least one display device; and machine readable code stored in said memory device and executable by said processor to cause said processor to:
implement a plurality of game turns comprising:
selecting, at said at least one game server, at least one called game indicia from a set of game indicia;
transmitting information regarding said at least one called game indicia to be displayed at said at least one display device of said first gaming machine and said at least one display device of said second gaming machine;
determining, at said at least one game server, a first player of said two or more players to select said at least one called game indicia; and
permitting said first player to select said at least one called game indicia to collect said game indicia while preventing each remaining player of said two or more players from collecting said game indicia;
and, at the end of said plurality of game turns:
evaluate an outcome of said game with reference to the game indicia collected by each player; and
providing a credit balance increasing award when at least one winning game outcome is obtained.

14. The system in accordance with claim 13 wherein each player is required to collect a set of N game indicia and said plurality of game turns comprises at least N*2.

15. The system in accordance with claim 13 wherein said set of game indicia comprises one or more decks of playing cards.

16. The system in accordance with claim 13 wherein said called game indicia comprises a playing card.

17. The system in accordance with claim 13 further comprising associating said called game indicia with a hand of said first player to select said called game indicia.

18. The system in accordance with claim 13 wherein said evaluating comprises evaluating said game indicia collected by each player for a highest poker hand ranking.

19. The system in accordance with claim 13 further comprising machine readable code executable by said processor to allow said first player to select said called game indicia to replace another game indicia associated with a hand of said first player with said called game indicia.

20. The system in accordance with claim 13 further comprising machine readable code executable by said processor to allow said first player to select said called game indicia to discard said collected called game indicia.

21. The system in accordance with claim 13 wherein said first player to select said called gaming indicia comprises a first player of said two or more players to provide a designated input to their associated gaming machine.
